(19) United States
(12) Patent Application Publication
(10) Pub. No.: US 2026/0187664 A1
(43) Pub. Date: Jul. 2, 2026

(54) MODELING DEVICE BASED ON CLEARING AND SETTLEMENT MECHANISMS OF MULTI-PRODUCT ELECTRICITY MARKET

(71) Applicant: South China University of Technology, Guangzhou City (CN)

(72) Inventors: Zhaoxia JING, Guangzhou City (CN); Jingkang FENG, Guangzhou City (CN); Yuxuan ZHAO, Guangzhou City (CN)

(73) Assignee: South China University of Technology, Guangzhou City (CN)

(21) Appl. No.: 19/434,608

(22) Filed: Dec. 29, 2025

(30) Foreign Application Priority Data
Jan. 2, 2025 (CN) 202510001398.9

(51) Int. Cl. G06Q 30/0201; G06Q 50/06

(52) U.S. Cl. CPC G06Q 30/02017; G06Q 50/06

(57) ABSTRACT

Provided is a modeling device based on clearing and settlement mechanisms of a multi-product electricity market, including: a processor, a memory and an input device; the processor is configured to determine key concepts in an electricity market, the key concepts comprise homogeneous products, heterogeneous products, product groups, and product conversion; for data related to a product input via the input device, the processor is configured to determine bid function-based data and actual function-based data; construct a general model for bidding and settlement in a centralized auction market and a general model for auction market clearing; and store the general model for bidding and settlement in the centralized auction market and the general model for auction market clearing in the memory.

### CROSS REFERENCE TO RELATED APPLICATION

This patent application claims the benefit and priority of Chinese Patent Application No. 202510001398.9, filed with the China National Intellectual Property Administration on Jan. 2, 2025, the disclosure of which is incorporated by reference herein in its entirety as part of the present application.

### TECHNICAL FIELD

The present disclosure relates to the electricity market, and in particular to a modeling device based on clearing and settlement mechanisms of a multi-product electricity market.

### BACKGROUND

To learn from the development experience of advanced electricity markets and provide insights and suggestions for electricity market construction, many scholars have conducted comprehensive review studies on domestic and international electricity markets from various aspects. Current literature research either does not utilize mathematical modeling or lacks in-depth analysis of various factors in clearing or settlement models, failing to obtain research conclusions that capture the core issues. Therefore, it is necessary to design a general formula modeling method for clearing and settlement mechanisms of a multi-product electricity market, to intuitively reveal the commonalities of various mechanisms from a perspective of influencing factors, and to explain why some mechanisms with vastly superficial differences can achieve results close to cost minimization. Additionally, the general formula can help identify the causes and consequences of common fallacies in existing studies and provide a universal tool for product design in the future.

### SUMMARY

To overcome the above shortcomings and deficiencies of the prior art, an objective of the present disclosure is to provide a modeling device based on clearing and settlement mechanisms of a multi-product electricity market.

The objective of the present disclosure is achieved by the following technical solutions:
A modeling device based on clearing and settlement mechanisms of a multi-product electricity market is provided, including: a processor, a memory and an input device;
where the processor is configured to determine key concepts in an electricity market, where the key concepts include homogeneous products, heterogeneous products, product groups, and product conversion;
for data related to a product input via the input device, the processor is configured to determine bid function-based data and actual function-based data; construct a general model for bidding and settlement in a centralized auction market and a general model for auction market clearing; and store the general model for bidding and settlement in the centralized auction market and the general model for auction market clearing in the memory.

Further, the homogeneous products comprise mutually substitutable products in multi-product transactions, while the heterogeneous products comprise products that are not mutually substitutable.

A plurality of products with common costs are grouped into one product group, and group products are divided into homogeneous product groups and heterogeneous product groups based on whether products within a product group are mutually substitutable.

The product conversion refers to conversion of products within the heterogeneous product group, and facilities enabling the conversion are conversion facilities.

Further, the bid function-based data includes:
costs or benefits calculated based on bid functions of suppliers or consumers, that is, bid costs or bid benefits;
a difference between total bid benefits of all consumers and total bid costs of all suppliers in the electricity market, that is, market surplus;
profits of market entities calculated based on clearing prices and bids, that is, market benefits; and
a difference between a total market revenue and a total market expenditure from a perspective of a market operator settled according to market clearing results and settlement rules, that is, settlement surplus.

Further, the actual function-based data includes:
costs or benefits calculated based on actual cost or benefit functions of suppliers or consumers, that is, actual costs or actual benefits, where the actual costs do not include any opportunity costs;
profits of market entities calculated by using actual functions, that is, actual profits;
and
a difference between total actual benefits of all consumers and total actual costs of all suppliers, that is, total social welfare.

Further, the processor is configured to construct the general model for bidding and settlement in the centralized auction market by:
formulating naming rules for functions and variables;
determining representation forms of product quantities;
establishing general function representations for bids, costs, benefits, and settlement; and
establishing general representations for welfare and surplus.

Further, the processor is configured to construct the general model for auction market clearing by regarding market clearing as an optimization problem.

Further, the processor is configured to construct the general model for auction market clearing by the following ways:
decision variables are three-dimensional vectors q^{s} and q^{d}; when all products in the electricity market are homogeneous products or all products in the electricity market adopt single-sided bidding, the decision variables become two-dimensional accordingly; and an objective function of market clearing is to maximize market surplus, expressed as follows:

$$max {R}^{co} ( {q}^{s} , {q}^{d} ) = max ( {R}^{do} ( {q}^{d} ) - {R}^{so} ( {q}^{s} ) ) .$$

Further, when a user-side bid function is a fixed demand volume independent of market prices, total bid benefits of consumers are a constant, and the objective function of market clearing is simplified to minimize total bid costs of all suppliers, as follows:

$$min {R}^{so} ( {q}^{s} ) .$$

Further, constraints for electricity market clearing are divided into three major categories, including individual constraints for market entities, market public constraints, and market supply-demand balance constraints, where the individual constraints for market entities are divided into supplier constraints and consumer constraints.

Further, if there are product conversion facilities in the electricity market, a supply volume and a demand volume of each type of product in the electricity market are possibly unequal; the market supply-demand balance constraints need to be rewritten by introducing a “conversion entity” denoted by a serial number “0”, and the rewritten constraints are expressed as follows:

$${\sum }_{i = 1}^{{N}^{s}} {q}_{i , m}^{s} - {\sum }_{j = 1}^{{N}^{d}} {q}_{j , m}^{d} = {q}_{0 , m}^{c}$$

$${\sum }_{i = 1}^{{N}^{s}} {q}_{i , n}^{s} - {\sum }_{j = 1}^{{N}^{d}} {q}_{j , n}^{d} = - {q}_{0 , n}^{c}$$

$${q}_{0 , m}^{c} + {q}_{0 , n}^{c} - {q}_{0 , mn}^{c , loss} = 0$$

where

$${q}_{0 , m}^{c} and {q}_{0 , n}^{c}$$

represent conversion volumes of two products associated with the conversion entity, with a positive value indicating transfer-out and a negative value indicating transfer-in, and

$${q}_{0 , mn}^{c , loss}$$

represents a loss incurred during product conversion.

Compared with the prior art, the present disclosure has the following advantages and beneficial effects.

The present disclosure clarifies the concepts of product groups, product conversion, conversion facilities, market benefits, and social welfare in the electricity market, and defines bid function-based data and actual function-based data to indicate more specific properties of the data. The present disclosure proposes eight general expressions for product transaction volumes and general functional expressions for describing bids, costs, and benefits, as well as a series of derived expressions for market surplus, objective functions, and clearing constraints. The present disclosure can provide mathematical models for various bidding and settlement mechanisms to compare differences and commonalities among different mechanisms. The proposed concepts and general modeling can serve as a reference for future research, enabling better understanding and expression of electricity market issues, making market mechanism research more standardized, facilitating comparison and reference between different studies, and promoting the development of the discipline.

### BRIEF DESCRIPTION OF THE DRAWINGS

FIG. 1 is a schematic diagram of a structure of a modeling device according to an embodiment of this application.

### DETAILED DESCRIPTION OF THE EMBODIMENTS

The present disclosure is further described below with reference to the embodiment, but the implementations of the present disclosure are not limited thereto.

### EMBODIMENT

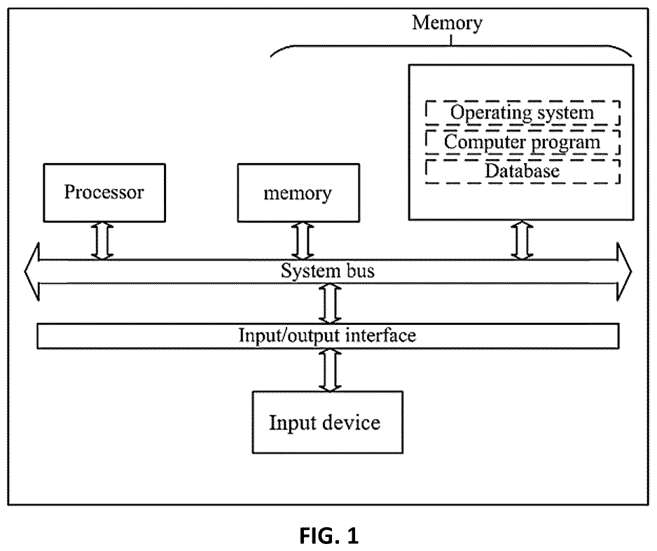

In an exemplary embodiment, a modeling device is provided. The modeling device may be a server or a terminal, and an internal structure thereof may be as shown in FIG. 1. The modeling device includes a processor, a memory and an input device, where the input device is connected to an input/output (I/O) interface. The processor, the memory, and the I/O interface are connected through a system bus. The memory of the modeling device stores an operating system, a computer program, and a database. The processor of the modeling device performs the computer program stored in the memory to implement specific functions.

The processor is configured to determine key concepts in an electricity market; for data related to a product input via the input device, the processor is configured to determine bid function-based data and actual function-based data; construct a general model for bidding and settlement in a centralized auction market and a general model for auction market clearing; and store the general model for bidding and settlement in the centralized auction market and the general model for auction market clearing in the memory.

Specifically, key concepts in an electricity market are determined, where the key concepts include homogeneous products, heterogeneous products, product groups, and product conversion.

### Specifically:

Mutually substitutable products in multi-product transactions are defined as homogeneous products, while products that are not mutually substitutable are defined as heterogeneous products.

A plurality of products with common costs can be grouped into one product group, and the group products can be divided into homogeneous product groups and heterogeneous product groups based on whether products within a product group are mutually substitutable.

The product conversion refers to conversion of products within the heterogeneous product group, and facilities enabling the conversion are conversion facilities. Conversion facilities in the electricity market include commercial facilities participating in market bidding, and public facilities not participating in bidding, both of which have the same physical effect.

Bid function-based data and actual function-based data are determined.

Considering the existence of market power, market entities will actually adopt strategic bidding to a certain extent to increase profits instead of bidding entirely based on their actual costs. When studying market benefits and social welfare, it is necessary to introduce bid function-based data and actual function-based data.

The bid function-based data includes:
costs or benefits calculated based on bid functions of suppliers or consumers, that is, bid costs or bid benefits;
a difference between total bid benefits of all consumers and total bid costs of all suppliers in the electricity market, that is, market surplus;
profits of market entities calculated based on clearing prices and bids, that is, market benefits; and
a difference between a total market revenue and a total market expenditure from a perspective of a market operator settled according to market clearing results and settlement rules, that is, settlement surplus.

The actual function-based data includes:
costs or benefits calculated based on actual cost or benefit functions of suppliers or consumers, that is, actual costs or actual benefits, where the actual costs do not include any opportunity costs;
profits of market entities calculated by using actual functions, that is, actual profits; and
a difference between total actual benefits of all consumers and total actual costs of all suppliers, that is, total social welfare.

A general model for bidding and settlement in a centralized auction market is constructed, which is specifically as follows:

The naming rules for functions and variables are as follows: F denotes a total bid function, a total cost/benefit function, or a total settlement function; f denotes sub-items within these functions; R represents market surplus, C represents market cost, and q represents the quantity of products. Superscripts indicate specific function types: The first character is s, d, or c, where s represents a supply side, d represents a demand side, and c represents a market operator or the market as a whole. The second character is o, s, or r, where o represents bid-related costs/benefits/market surplus, or the like; s represents market settlement-related prices/settlement surplus, or the like; and r represents indicators related to actual costs/benefits/market welfare. If the first or second character is not one of the aforementioned letters, additional explanations will be provided. The third character is related to specific scenarios and will be explained separately. Subscripts indicate serial numbers of market entities, products, product groups, or the like: The first character represents a market entity serial number; the second character represents a product serial number and a serial number of common costs related to multiple products; the third character is related to specific scenarios and will be explained separately. Σ in the superscripts or subscripts indicates an overall parameter. In vector variables, the subscripts of vector elements are separated by “,” to distinguish the serial numbers of variables in different dimensions; if there is a “;”, the serial number before “;” is used to distinguish vector names, and the serial number after “;” is used to distinguish the serial numbers of variables within the vector.

The application method of the product quantity expression formulas is illustrated by the following example.

$${q}^{s} = {[ {q}_{i , m , b}^{s} ]}_{{N}^{s \times M \times {N}^{sol}}}$$

$${q}^{s , pr} = {[ {q}_{i , m}^{s} ]}_{{N}^{s \times M}}$$

$${q}_{i , m}^{s} = {[ {q}_{i , m ; b}^{s} ]}_{{N}^{so 1}}$$

$${q}_{i , m}^{s} = {\sum }_{b = 1}^{{N}^{so 1}} {q}_{i , m , b}^{s}$$

$${q}_{i}^{s} = {[ {q}_{im , b}^{s} ]}_{M \times {N}^{so 1}}$$

$${q}_{i}^{s , pr} = {[ {q}_{i , m}^{s} ]}_{M}$$

$${q}_{i}^{s} = {\sum }_{m = 1}^{M} {q}_{i ; m}^{s}$$

$${q}^{s} = {\sum }_{i = 1}^{{N}^{s}} {q}_{i}^{s}$$

N^{s}, M and N^{so1} denote the number of supply-side entities, the number of heterogeneous product types, and the number of bid segments, respectively, all taking maximum values; q^{s} and q^{s,pr} represent supply quantity vectors of each supply-side entity for each bid segment of each heterogeneous product, and supply quantity vectors of each supply-side entity for each heterogeneous product, respectively;

$${q}_{i , m , b}^{s} and {q}_{i ; m , b}^{s}$$

represent a supply quantity of supply entity i for a b-th bid segment of an m-th heterogeneous product;

$${q}_{i , m}^{s} and {q}_{i , m}^{s}$$

represent a segment-wise bid supply quantity vector and a total supply quantity of supply entity i for the m-th heterogeneous product, respectively;

$${q}_{i}^{s} and {q}_{i}^{s}$$

represent a supply quantity vector and a total supply quantity of supply entity i for each heterogeneous product, respectively; and q^{s} is a total transaction volume of all products.

General functions for bids, costs, benefits and settlement are illustrated by taking the bid function of supplier i as an example, where the bid function of supplier i is defined as follows:

$${F}_{i}^{so} ( {q}_{i}^{s} ) = {F}_{i}^{so 1} ( {q}_{i}^{s} ) + {F}_{i}^{so 2} ( {q}_{i}^{s} ) + {F}_{i}^{so 3} ( {q}_{i}^{s} )$$

$${F}_{i}^{so 1} ( {q}_{i}^{s} ) = {\sum }_{m = 1}^{M} ( {\sum }_{b = 1}^{{N}^{so 1}} {f}_{i , m , b}^{so 1} ( {q}_{i , m , b}^{s} ) )$$

$${F}_{i}^{sO 2} ( {q}_{i}^{s} ) = {\sum }_{m = 1}^{M} ( {\sum }_{c = 1}^{{N}^{so 2}} {f}_{i , m , c}^{so 2} ( {q}_{i , m}^{s} ) )$$

$${F}_{i}^{so 3} ( {q}_{i}^{s} ) = {\sum }_{g = 1}^{{N}^{so 3}} {f}_{i , g}^{so 3} ( {q}_{i}^{s , pr} )$$

$${F}_{i}^{s o}$$

represents the bid function of supplier i;

$${F}_{i}^{so 1} , {F}_{i}^{so 2} , {F}_{i}^{so 3}$$

represent a single-segment cost function related only to a single product, a common cost function for homogeneous product groups, and a common cost function for heterogeneous product groups, respectively;

$${f}_{i , m , b}^{so 1} , {f}_{i , m , c}^{so 2} , and {f}_{i , u , g}^{so 3}$$

are sub-items of the respective cost functions. M and N^{so3} are the number of common cost items for homogeneous product groups and the number of common cost items for heterogeneous product groups, respectively, taking the maximum values of the relevant number of items. The foregoing describes the supply-side bid function. The demand-side bid function is similar, which can be derived by changing the first character of the superscript from “s” to “d”. The functions for actual costs, actual benefits, as well as the market revenue of suppliers and the market expenditure of consumers are similar to the supply-side bid function and the demand-side bid function respectively, and can be derived by changing the second character of the superscript from “o” to “r” and “s” respectively.

Formulas related to welfare and surplus are explained by taking market surplus as an example, which are as follows.

$${R}_{i}^{so} = {F}_{i}^{so} ( {q}_{i}^{s} )$$

$${R}^{so} = {\sum }_{i = 1}^{{N}^{s}} {R}_{i}^{so} = {F}^{so} ( {q}^{s} )$$

$${R}_{j}^{do} = {F}_{j}^{do} ( {q}_{j}^{d} )$$

$${R}_{do} = {\sum }_{j = 1}^{{N}^{d}} {R}_{j}^{do} = {F}^{do} ( {q}^{d} )$$

$${R}^{co} = {R}^{do} - {R}^{so}$$

R^{do}, R^{so} and R^{co} represent a total bid benefit on the demand side, a total bid cost on the supply side, and total market surplus, respectively.

$${R}_{j}^{do} and {R}_{i}^{so}$$

represent a bid benefit of a j-th consumer and a bid cost of an i-th supplier, respectively.

A general model for auction market clearing is constructed, which is specifically as follows: Market clearing can be regarded as an optimization problem.

Decision variables are the three-dimensional vectors q^{s} and q^{d}. When all products in the electricity market are homogeneous products or all products in the electricity market adopt single-sided bidding, the decision variables become two-dimensional accordingly.

An objective function of market clearing is to maximize market surplus, expressed as follows:

$$max {R}^{co} ( {q}^{s} , {q}^{d} ) = max ( {R}^{do} ( {q}^{d} ) - {R}^{so} ( {q}^{s} ) ) .$$

In some markets, the bid function on the user side is a fixed demand volume independent of market prices. In this case, total bid benefits of consumers are a constant, and the objective function of market clearing can be simplified to minimize total bid costs of all suppliers, which is expressed as follows:

$$min {R}^{s o} ( {q}^{s} ) .$$

Constraints for market clearing can be divided into three major categories: individual constraints for market entities, market public constraints, and market supply-demand balance constraints. The individual constraints for market entities are divided into supplier constraints and consumer constraints. The above constraints are expressed as follows.

$${\underline{b}}_{i , w}^{s} \leq {g}_{i , w}^{s} ( {q}_{i}^{s} ) \leq {\overline{b}}_{i , w}^{s} , w = 1 , 2 , … {N}_{i}^{s g}$$

$${\underline{b}}_{j , w}^{d} \leq {g}_{j , w}^{d} ( {q}_{j}^{d} ) \leq {\overline{b}}_{j , w}^{d} , w = 1 , 2 , … , {N}_{j}^{d g}$$

$${\underline{b}}_{w}^{c} \leq {g}_{w}^{s y s} ( {q}^{s} , {q}^{d} ) \leq {\overline{b}}_{w}^{c} , w = 1 , 2 , … , {N}^{s y s}$$

$${\sum }_{i = 1}^{{N}^{s}} {q}_{i , m}^{s} - {\sum }_{j = 1}^{{N}^{d}} {q}_{j , m}^{d} = 0$$

$${N}_{i}^{s g} , {N}_{j}^{d g}$$

and N^{sys} represent a number of individual constraints for supplier i, a number of individual constraints for consumer j, and a number of public resource constraints, respectively; the letters b and b̅ represent lower and upper limits of each constraint, respectively; and w in the subscript represents the serial number of the constraint.

If there are product conversion facilities in the market, a supply volume and a demand volume of each type of product in the electricity market are possibly unequal; the market supply-demand balance constraints need to be rewritten by introducing a “conversion entity” denoted by a serial number “0”, and the rewritten constraints are expressed as follows:

$${\sum }_{i = 1}^{{N}^{s}} {q}_{i , m}^{s} - {\sum }_{j = 1}^{{N}^{d}} {q}_{j , m}^{d} = {q}_{0 , m}^{c}$$

$${\sum }_{i = 1}^{{N}^{s}} {q}_{i , n}^{s} - {\sum }_{j = 1}^{{N}^{d}} {q}_{j , n}^{d} = - {q}_{0 , n}^{c}$$

$${q}_{0 , m}^{c} + {q}_{0 , n}^{c} - {q}_{0 , mn}^{c , loss} = 0$$

$${q}_{0 , m}^{c} and {q}_{0 , n}^{c}$$

represent conversion volumes of two products associated with the conversion entity, with a positive value indicating transfer-out and a negative value indicating transfer-in.

$${q}_{0 , mn}^{c , 1 o s s}$$

represents a loss incurred during product conversion.

The present disclosure is applicable to centralized markets. The market clearing and settlement process is abstracted into a general optimization model, where objective functions, constraints and other elements are involved. Multi-attribute product variables are described by means of a high-dimensional vector, achieving adaptability to clearing and settlement scenarios of different products as well as various clearing and settlement mechanisms.

The present disclosure further provides a modeling system based on clearing and settlement mechanisms of a multi-product electricity market. The system includes a concept definition module, a module for acquiring bid function-based data, a module for acquiring actual function-based data, and a general model construction module.

The modeling method of the present disclosure defines the concepts of bid costs and actual costs. When a market entity submits bids based on actual costs without adopting strategic behaviors, the bid costs can reflect the actual costs.

The above embodiments are preferred implementations of the present disclosure, but the implementations of the present disclosure are not limited to these embodiments, and any other changes, modifications, substitutions, combinations and simplifications made without departing from the spirit and principle of the present disclosure shall be equivalent replacement means, and shall be included in the protection scope of the present disclosure.

What is claimed is:

1. A modeling device based on clearing and settlement mechanisms of a multi-product electricity market, comprising a processor, a memory and an input device:
wherein the processor is configured to determine key concepts in an electricity market, wherein the key concepts comprise homogeneous products, heterogeneous products, product groups, and product conversion;
for data related to a product input via the input device, the processor is configured to determine bid function-based data and actual function-based data; construct a general model for bidding and settlement in a centralized auction market and a general model for auction market clearing; and store the general model for bidding and settlement in the centralized auction market and the general model for auction market clearing in the memory.

2. The modeling device according to claim 1, wherein the homogeneous products comprise mutually substitutable products in multi-product transactions, while the heterogeneous products comprise products that are not mutually substitutable;
a plurality of products with common costs are grouped into one product group, and group products are divided into homogeneous product groups and heterogeneous product groups based on whether products within a product group are mutually substitutable; and
the product conversion refers to conversion of products within the heterogeneous product group, and facilities enabling the conversion are conversion facilities.

3. The modeling device according to claim 2, wherein the bid function-based data comprises:
costs or benefits calculated based on bid functions of suppliers or consumers, that is, bid costs or bid benefits;
a difference between total bid benefits of all consumers and total bid costs of all suppliers in the electricity market, that is, market surplus;
profits of market entities calculated based on clearing prices and bids, that is, market benefits; and
a difference between a total market revenue and a total market expenditure from a perspective of a market operator settled according to market clearing results and settlement rules, that is, settlement surplus.

4. The modeling device according to claim 2, wherein the actual function-based data comprises:
costs or benefits calculated based on actual cost or benefit functions of suppliers or consumers, that is, actual costs or actual benefits, wherein the actual costs do not include any opportunity costs;
profits of market entities calculated by using actual functions, that is, actual profits; and
a difference between total actual benefits of all consumers and total actual costs of all suppliers, that is, total social welfare.

5. The modeling device according to claim 1, wherein the processor is configured to construct the general model for bidding and settlement in the centralized auction market by following ways:
formulating naming rules for functions and variables;
determining representation forms of product quantities;
establishing general function representations for bids, costs, benefits, and settlement; and
establishing general representations for welfare and surplus.

6. The modeling device according to claim 1, wherein the processor is configured to construct the general model for auction market clearing by regarding market clearing as an optimi ation problem.

7. The modeling device according to claim 6, wherein the processor is configured to construct the general model for auction market clearing by following ways:
decision variables are three-dimensional vectors q^{s} and q^{d}; when all products in the electricity market are homogeneous products or all products in the electricity market adopt single-sided bidding, the decision variables become two-dimensional accordingly; and
an objective function of market clearing is to maximize market surplus, expressed as follows:
$$max {R}^{c o} ( {q}^{s} , {q}^{d} ) = max ( {R}^{d o} ( {q}^{d} ) - {R}^{s o} ( {q}^{s} ) ) .$$

8. The modeling device according to claim 7, wherein when a user-side bid function is a fixed demand volume independent of market prices, total bid benefits of consumers are a constant, and the objective function of market clearing is simplified to minimize total bid costs of all suppliers, as follows:
$$min {R}^{s o} ( {q}^{s} ) .$$

9. The modeling device according to claim 8, wherein constraints for electricity market clearing are divided into three major categories comprising individual constraints for market entities, market public constraints, and market supply-demand balance constraints, wherein the individual constraints for market entities are divided into supplier constraints and consumer constraints.

10. The modeling device according to claim 9, wherein in a case that there are product conversion facilities in the electricity market, a supply volume and a demand volume of each type of product in the electricity market are possibly unequal; the market supply-demand balance constraints are rewritten by introducing a “conversion entity” denoted by a serial number “0”, and the rewritten constraints are expressed as follows:
$${\sum }_{i = 1}^{{N}^{s}} {q}_{i , m}^{s} - {\sum }_{j = 1}^{{N}^{d}} {q}_{j , m}^{d} = {q}_{0 , m}^{c}$$
$${\sum }_{i = 1}^{{N}^{s}} {q}_{i , n}^{s} - {\sum }_{j = 1}^{{N}^{d}} {q}_{j , n}^{d} = - {q}_{0 , n}^{c}$$
$${q}_{0 , m}^{c} + {q}_{0 , n}^{c} - {q}_{0 , mn}^{c , 1 o s s} = 0$$
wherein q_{0,m}^{c} and q_{0,n}^{c} represent conversion volumes of two products associated with the conversion entity, with a positive value indicating transfer-out and a negative value indicating transfer-in, and
$${q}_{0 , mn}^{c , loss}$$
represents a loss incurred during product conversion.
